(19) United States
(12) Patent Application Publication
(10) Pub. No.: US 2007/0019653 A1
(43) Pub. Date: Jan. 25, 2007

(54) Transport of ethernet frames over an sdh network

(76) Inventors: Aldo Bolle, Vastra Frolunda (SE); Orjan Eriksson, Askim (SE)

Correspondence Address: NIXON & VANDERHYE, PC, 901 NORTH GLEBE ROAD, 11TH FLOOR, ARLINGTON, VA, 22203, US

(21) Appl. No.: 10/575,762

(22) PCT Filed: Oct. 13, 2003
(86) PCT No.: PCT/SE03/01584

§ 371 Date: Apr. 13, 2006

(51) Int. Cl. H04L 12/56

(52) U.S. Cl. 370/395.51

(57) ABSTRACT

The invention refers to a method of transmitting Ethernet data frames from a first local area network (LAN) to a second local area network (LAN) comprising mapping Ethernet frames from the first local area network onto Plesiochronous Digital Hierarchy format via Generic Framing Procedure (GFP) and transmitting the mapped Ethernet frames via a one or multiple En streams to an optional SDH-level network. The transmission is received at the second local area network through the optional SDH-level network via one or multiple En streams-network, and the Ethernet frames are demapped from the first local area network via Generic Framing Procedure, and transmitted into the second local area network.

### TECHNICAL FIELD

The present invention relates to the transmission of Ethernet data frames from a first local area network to a second local area network. By means of the invention, such transport is greatly facilitated, in that a plurality of intermediate steps which have been used hitherto can be eliminated.

### BACKGROUND ART

Local Area Networks (LAN) is a technology that has lately enjoyed a massive success, with the most widely spread transport mechanism in LAN:s being Ethernet. However, as LAN/Ethernet becomes more and more popular, there has arisen a demand from users to be able to connect Ethernet LAN:s at different sites to each other, said sites being geographically separated by large distances, with the user demand being for the ability to establish connection between Ethernet sites separated by more or less arbitrarily large distances.

Since the Ethernet technology was originally not conceived for this use, but rather was intended for LAN use at one and the same site, this demand has caused a a problem for network operators. One of these problems is that Ethernet is a frame based transport technology, while the technologies most frequently used for transporting data between different network locations is based on the continuous transmission of data, by means of the so called Synchronous Digital Hierarchy, (SDH), or the Synchronous Optical NETwork (SONET), usually in combination with and Plesiochronous Digital Hierarchy (PDH).

The PDH technology is often used as an intermediate level between Ethernet LAN:s and the SDH-level or SONET due to the fact that, in most cases, the distance that Ethernet allows data to be transported makes it unfeasible to connect the Ethernet directly to the SDH- or SONET-level, and also due to to the limited penetration of SDH/SONET networks.

Transport of Ethernet frames between two different LAN:s that are geographically separated from one another has thus hitherto been associated with costly and complex equipment for the users, as well as a high degree of network complexity for the operators of the networks.

### DISCLOSURE OF THE INVENTION

From what has been described above, it will be realized that there exists a need for a method and a system for the transmission of Ethernet frames between a first and a second LAN which are situated at different geographical sites, which method and system afford a relatively low degree of complexity and cost as compared to present day solutions.

This need is addressed by the present invention in that it discloses a method of transmitting Ethernet data frames from a first local area network to a second local area network (LAN), comprising the steps of mapping Ethernet frames from the first local area network onto Plesiochronous Digital Hierarchy (PDH) network via Generic Framing Procedure (GFP), and transmitting said mapped Ethernet frames via the first PDH-network to an SDH-level network. The transmission is received at the second local area network through the SDH-level network via a second PDH-network, and the Ethernet frames from the first local area network are demapped via Generic Framing Procedure and transmitted into the second local area network.

Suitably, the PDH network consists of one or multiple E1 or T1-streams, but can also consist, for example, of one or multiple E2, T2, E3, T3, or E4, depending on the transmission need. In En and Tn, n is one of the numerals 1, 2, 3, or 4, and signifies the actual bit rate in the PDH network according to existing standards.

Also, said mapping is preferably carried out at a junction point between the first Ethernet LAN and a first PDH network, and equally suitably, said demapping is carried out at a junction point between the second PDH network and the second Ethernet LAN.

The invention is also directed to a system for transmitting Ethernet data frames from a first local area network (LAN) to a second local area network (LAN), the system comprising means for mapping Ethernet frames from the first local area network onto SDH/SONET-format via Generic Framing Procedure (GFP), and means for transmitting said mapped Ethernet frames via a first PDH-network to an SDH/SONET-level network.

Said system preferably, but not necessarily, also comprises means for receiving the transmission at the second local area network through the SDH-level network via a second En-network, means for demapping the Ethernet frames from the first local area network via Generic Framing Procedure, and means for transmitting said demapped Ethernet frames into the second local area network.

### BRIEF DESCRIPTION OF THE DRAWINGS

The invention will be described in closer detail in the following, with reference to the enclosed drawings, in which

FIG. 1 shows a principal diagram of a first embodiment of the invention, and

FIG. 2 shows a principal diagram of a second embodiment of the invention.

### EMBODIMENTS

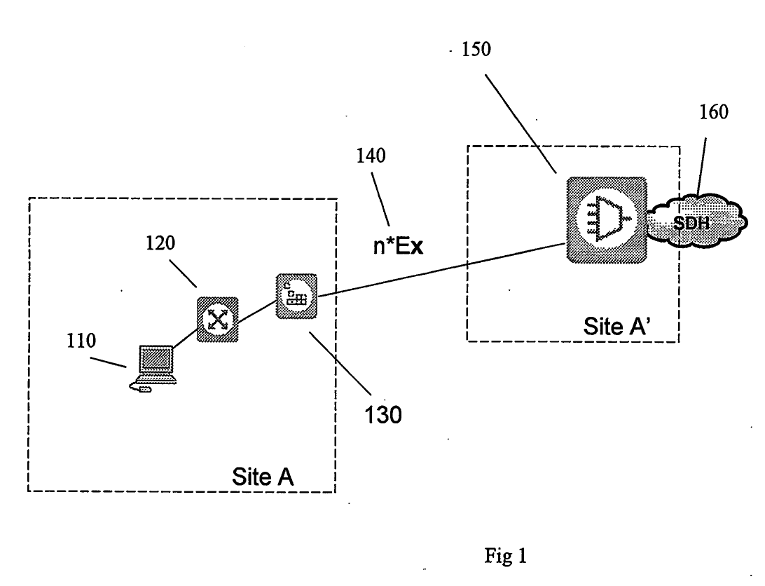

FIG. 1 shows a first embodiment of a system according to the invention, which system will also operate according to the method of the invention.

At a first site A, there exists a first Local Area Network, a LAN, 110, which uses the Ethernet protocol. Users within the first LAN 110 at site A wish to be able to communicate not only with each other, but also with the users of a second Ethernet LAN at a second (not shown) site, referred to as B. At an intermediate site A′ there exists an SDH (Synchronous Digital Hierarchy) or SONET network through which the site B may be directly or indirectly reached.

Due to the distance between sites A and B, it is not feasible to establish direct Ethernet communication between the first and the second site. Instead, use is made of intermediary carriers for transport of the Ethernet frames, first between A and the intermediate site A′: from A, a connection is established to a higher level network 150 at A′ known as an SDH-network (Synchronous Digital Hierarchy), via one or multiple intermediate data carriers 140 known as PDH carriers. The higher level network may also be an SONET-network, the invention can be applied equally to such networks.

The PDH carrier data rate is generally 2 Mb/s and is referred to as an E1 carrier. There are other versions of this carrier which have higher capacities, e.g. 8 Mb/s and 34 Mb/s, which are referred to, in turn, as E2 and E3. Also 1.5 Mb/s and multiple of 1.5 Mb/s data carriers may be used, referred to as T1, T2 and T3. All of these may be used in a system according to the invention. As a generic reference term, these carriers will be referred to as En, where the n may be substituted by any one of the numerals 1, 2, 3 or 4.

As a connecting means between the En-carrier and the LAN 110, use may be made of a so called Ethernet switch 120.

According to the invention, at a junction point between the Ethernet LAN and the E1 network, the data frames from the LAN are mapped into GFP frames. Said mapping may be carried out by means 130 designed in software or hardware, or a combination of software and hardware, but in a preferred embodiment, the mapping means 130 is designed entirely in software.

The GFP frames are then transmitted via one or several En carriers, 140, embodied by, for example, microwave radio links, to a physical station in the SDH-level 160 of the network. One of the merits of the invention is that, unlike the technology previously used for connecting Ethernet to SDH via En, GFP frames can be transported via SDH without being “unpacked” at the connection between the SDH-network and the En-carrier, thus enabling savings both in equipment and work.

In fact, the Ethernet frames, having been mapped into GFP frames, can be transported the entire path without any additional packing/unpacking, if that is the solution desired by the network operator. The term “the entire path” here includes a junction point between the PDH or SDH or SONET-network and the receiver of the Ethernet frames at site B (not shown in the drawings). The reception of the GFP-frames at the second site, B, will be elaborated upon in more detail later on in this description.

The GFP frames to which the Ethernet frames have been mapped at the first junction point between site A and the En network can be transported through the SDH-network in a variety of ways which are well known to those in the field, and will thus not be elaborated upon in more detail here. However, one particularly advantageous way of transporting said frames is by means of so called “virtual containers”, referred to as VC:s. This is a method well known to those skilled in the field, for which reason it won't be described in closer detail here. However, advantageously, the virtual concatenation is carried out by a function 150 for mapping the GFP frames into a suitable number of virtually concatenated so called VC-12 frames, i.e. n*VC-12.

The exact nature of the virtual container is determined by the amount of data to be transmitted through the system. As a generic term for such a virtual container, the term VCx is usually used, where the letter x is substituted by the type of virtual container used, such as, for example, VC12. Other examples of virtual containers that could be used in the present invention are, for example, VC11, VC4 and VC3.

Turning now to the receiving Ethernet LAN at the site referred to previously as B, the following takes place at this second end of the transmission path of the network: The transmitted GFP frames are received via the SDH-level network, via a En-carrier, 140′, suitably also a microwave radio link, and the Ethernet frames are demapped 130′ from GFP at a junction point between the second En-carrier and the second Ethernet LAN, and transmitted into the second Ethernet LAN network at A′. In similarity to the mapping described previously, the demapping 130′ can be carried out either by software or hardware or a suitable combination of both, but in a preferred embodiment, the demapping is carried out by software. Subsequent to the demapping from GFP, the received Ethernet frames are then distributed in the desired manner in the LAN by the ordinary LAN mechanism.

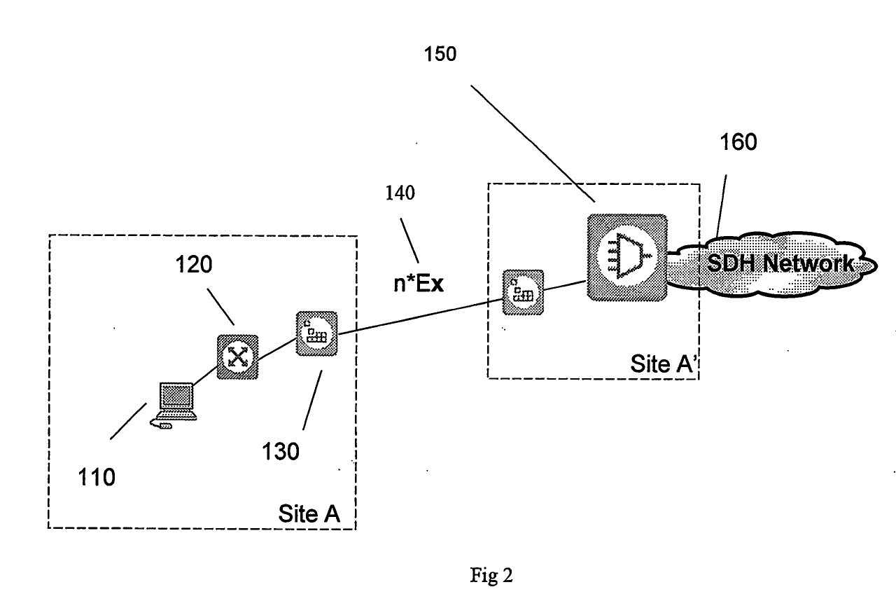

In FIG. 2, an alternative embodiment of the invention is shown: two Ethernet LAN sites, referred to again as A and B (not shown), are connected via similar connections as in the embodiment in FIG. 1, i.e. the two sites A and B are connected via respective En-carriers (in this case E1) to an intermediate SDH-network. The difference between the embodiment in FIG. 2 and the one described earlier in connection to FIG. 1 is that the Ethernet frames are mapped in to GFP at a junction point between the first LAN and the E1 carrier, and transported up to the SDH-level, where they are demapped, and subsequently “remapped” into GFP, and then transported across the SDH-network in virtual containers of the VCx-kind described earlier, preferably a number of VC12 containers, i.e. n*VC-12.

At the other end of the network shown in FIG. 2, although not explicitly shown, there is a mirror solution to the site referred to as A at the site B. This means that the site referred to as B comprises a suitable number of En-carriers, i,e. n*Ex which connect the SDH-network and the second Ethernet LAN. Upon arrival at the junction point between the SDH-network and the En-carriers, the GFP frames are demapped into Ethernet, and then remapped into GFP before being transmitted via the En-carrier to the second Ethernet LAN, where they are demapped into Ethernet frames, and transmitted into the Ethernet LAN by the ordinary LAN mechanism.

Naturally, a combination of the solutions presented in FIGS. 1 and 2 are also within the scope of the invention. Such a solution would mean that at, for example, site A, the network would comprise equipment for mapping Ethernet frames into GFP at the junction point between the LAN and the En-carriers, and the frames would then be transported through the SDH-network directly. At the other end the network would comprise equipment for demapping the GFP-frames into Ethernet frames, subsequent to which they would be mapped into GFP again, and transported via n*Ex-carriers to the Ethernet LAN, where they would again be demapped and distributed through the Ethernet LAN at B. It will be realized that the “mirror solution” to this would also be possible within the scope of the invention.

1. A method of transmitting Ethernet data frames from a first local area network (LAN) to a second local area network (LAN) comprising the steps of:
mapping Ethernet frames from the first local area network onto a Plesiochronous Digital Hierarchy (PDH) data stream via Generic Framing Procedure (GFP),
transmitting said mapped Ethernet frames via a first En-network to an SDH-level network,
receiving the transmission at the second local area network through the SDH-level network,
demapping the Ethernet frames from the first local area network via Generic Framing Procedure, and transmitting said demapped frames into the second local area network.

2. The method of claim 1, according to which said mapping is carried out at a junction point between the first Ethernet LAN and a first En-network.

3. The method of claim 1, according to which said demapping is carried out at a junction point between the second En-network and the second Ethernet LAN.

4. The method of claim 1, according to which the transport of the GFP frames through the SDH-network is carried out by means of so called virtual containers, VCx-containers.

5. A system for transmitting Ethernet data frames from a first local area network to a second local area network, comprising:
means for mapping Ethernet frames from the first local area network onto Plesiochronous Digital Hierarchy format via Generic Framing Procedure (GFP),
means for transmitting said mapped Ethernet frames via a first En-network to an PDH-level network.

6. The system of claim 5, additionally comprising means for:
receiving the transmission at the second local area network through the SDH-level network via a second En-network,
demapping the Ethernet frames from the first local area network via Generic Framing Procedure, and transmitting said demapped frames into the second local area network.

7. The system of claim 5, in which the means for said mapping is arranged at a junction point between the first Ethernet LAN and a first En-network.

8. The method of claim 6, according to which said means for demapping is arranged at a junction point between the second En-network and the second Ethernet LAN.

9. The system of claim 5, in which the transport of the GFP frames through the SDH-network is carried out by means of so called virtual containers, VCx-containers.
